(19) United States
(12) Patent Application Publication
(10) Pub. No.: US 2008/0186531 A1
(43) Pub. Date: Aug. 7, 2008

(54) IMAGE FORMING APPARATUS FOR PERFORMING PROCESSING FLOW AND CONTROL METHOD THEREFOR

(75) Inventor: Motoki Ikeda, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/938,109

(22) Filed: Nov. 9, 2007

(30) Foreign Application Priority Data
Dec. 19, 2006 (JP) 2006-341405

(51) Int. Cl. G06F 15/00

(52) U.S. Cl. 358/1.15

(57) ABSTRACT

An image forming apparatus is configured to manage a processing flow including a plurality of steps. The image forming apparatus includes a managing unit configured to manage a plurality of processing flows as one group, a designating unit configured to designate one group managed by the managing unit, and a detecting unit configured to detect a document. The image forming apparatus further includes a selecting unit configured to select a processing flow, which is to be executed, from among a plurality of processing flows included in the group designated by the designating unit according to a result of detection of the document by the detecting unit. Then, the image forming apparatus sequentially executes a plurality of steps included in the processing flow selected by the selecting unit.

### BACKGROUND OF THE INVENTION

1. Field of the Invention

The present invention relates to an image forming apparatus (e.g., multifuncaiton peripheral devices) configured to manage and execute a plurality of processing steps as a sequential processing flow.

2. Description of the Related Art

Recently, image forming apparatuses to be used in offices have been multifunctionalized like a multifunction peripheral. Users using a single multifunction image forming apparatus can utilize a plurality of functions, for example, a document reading function, a document printing function, a document sending function using a facsimile (FAX) or an electronic mail (e-mail), and a document storage function of storing read documents (i.e., electronic documents) on an internal hard disk drive (HDD).

Such functions provided by a multifunction image forming apparatus are not necessarily individually used. Sometimes, jobs are performed by combining a plurality of functions.

For example, in an office working environment (e.g. office counter work), a combination of such functions may be performed by a multifunction image forming apparatus as follows. Initially, document data can be generated using the reading function (scanning function) of the image forming apparatus to read an application form filled out by a customer. Then, the document data may be stored in the image forming apparatus by using the document storage function. In addition, the document data stored in the image forming apparatus can be sent to an external server by using the document sending function, such as an e-mail message function. The above described functions may be performed in a combination manner to carry out a business operation.

Office counter operations and other office operations often require an execution of various routine tasks. Thus, image forming apparatuses may be used frequently in a formulaic way, for example, as described above.

However, in certain cases, users may need to repeat similar operating steps and similar setting steps each time a routine task is to be executed. The necessity of manually entering user inputs corresponding to desired operating steps and settings each time a routine task is to be executed may degrade operability of the image forming apparatus and may cause erroneous operations to be performed.

To address the above described problems, an image forming apparatus has been devised, which manages the utilization of a plurality of such functions as a routine processing flow.

This image forming apparatus manages, for example, the steps of “reading a document”, “storing the document data”, and “sending the document data to an external server” in the above example, as a sequential processing flow. When a user instructs the image forming apparatus to execute this processing flow, the image forming apparatus sequentially executes the foregoing processing steps.

The processing flow is registered while being associated with a designating unit, such as a button. An associated process including a plurality of steps can be performed by a small number of user input operations, such as depression of this button. Therefore, the image forming apparatus is convenient.

Additionally, the conventional image forming apparatus can store detail data concerning setting in each of steps of the processing flow. Such detail data represents, for example, an address at which document data is stored, an address to which document data is sent, a size of paper on which a document is printed, the number of printed copies of a document, and data concerning imposition of a document.

Japanese Patent Application Laid-Open No. 2004-133926 discusses a multifunction peripheral serving as an image forming apparatus configured to display on an operation panel each selection button for selecting an instruction sheet corresponding to an instruction to be executed. The multifunctional peripheral analyzes the instruction sheet corresponding to the button selected through the operation panel. The multifunction peripheral sequentially calls service processing apparatuses (e.g., a copying machine, a facsimile machine, and a multifunction peripheral) according to information written on the instruction sheet to perform cooperative processing.

However, according to the conventional multifunction peripheral, only one instruction sheet corresponds to a single selection button. In other words, only one processing flow can be executed with one button selected by a user. Thus, as the number of processing flows to be managed increases, the number of instruction portions (e.g., selection buttons), each of which is displayed on the operation panel for executing an associated processing flow, is increased. Consequently, it is difficult for users to locate a desired one of the selection buttons.

Additionally, because many selection buttons are displayed on the operation panel, users may cause the multifunction peripheral to erroneously execute a processing flow differing from a desired one.

### SUMMARY OF THE INVENTION

An embodiment of the present invention is directed to an image forming apparatus configured to group a plurality of processing flows and to execute one of the grouped processing flows according to a result of detecting a document. Accordingly, the image forming apparatus can execute a user's desired one of the processing flows with display/instruction portions (e.g., selection buttons), the number of which is less than that of processing flows managed by the image forming apparatus.

According to an aspect of the present invention, an image forming apparatus configured to manage a processing flow including a plurality of steps includes a managing unit configured to manage a plurality of processing flows as one group, a designating unit configured to designate one group managed by the managing unit, a detecting unit configured to detect a document, a selecting unit configured to select a processing flow, which is to be executed, from among a plurality of processing flows included in the group designated by the designating unit according to a result of detection of the document by the detecting unit, and an executing unit configured to sequentially execute a plurality of steps included in the processing flow selected by the selecting unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image forming apparatus according to an exemplary embodiment of the present invention.

FIG. 2 is a functional block diagram illustrating a function of the image forming apparatus according to an exemplary embodiment of the present invention.

FIG. 3 is a block diagram illustrating an outline of a flow according to an exemplary embodiment of the present invention.

FIG. 4 is a diagram illustrating a display image displayed on a screen of the image forming apparatus according to an exemplary embodiment of the present invention.

FIG. 5 is a diagram illustrating another display image displayed on a screen of the image forming apparatus according to an exemplary embodiment of the present invention.

FIG. 6 is a diagram illustrating another display image displayed on the screen of the image forming apparatus according to an exemplary embodiment of the present invention.

FIG. 7 is a diagram illustrating another display image displayed on the screen of the image forming apparatus according to an exemplary embodiment of the present invention.

FIG. 8 is a diagram illustrating another display image displayed on the screen of the image forming apparatus according to an exemplary embodiment of the present invention.

FIG. 9 is a diagram illustrating another display image displayed on the screen of the image forming apparatus according to an exemplary embodiment of the present invention.

FIG. 10 is a diagram illustrating another display image displayed on the screen of the image forming apparatus according to an exemplary embodiment of the present invention.

FIG. 11 is a diagram illustrating another display image displayed on the screen of the image forming apparatus according to an exemplary embodiment of the present invention.

FIG. 12 is a flowchart illustrating a procedure according to a first exemplary embodiment of the present invention.

FIG. 13 is a flowchart illustrating the procedure according to the first exemplary embodiment of the present invention.

FIG. 14 is a diagram illustrating a display image displayed on the screen of the image forming apparatus according to an exemplary embodiment of the present invention.

FIG. 15 is a flowchart illustrating a procedure according to a second exemplary embodiment of the present invention.

FIG. 16 is a diagram illustrating a configuration of a system according to a third exemplary embodiment of the present invention.

FIG. 17 is a diagram illustrating a display image displayed on a screen of an image forming apparatus according to the third exemplary embodiment of the present invention.

FIG. 18 is a flowchart illustrating a procedure according to the third exemplary embodiment of the present invention.

FIG. 19 is a flowchart illustrating a procedure according to the third exemplary embodiment of the present invention.

FIG. 20 is a diagram illustrating a display image displayed according to a fourth embodiment of the present invention.

FIG. 21 is a diagram illustrating a display image displayed on a screen of an image forming apparatus according to the fourth exemplary embodiment of the present invention.

FIG. 22 is a flowchart illustrating a procedure according to the fourth exemplary embodiment of the present invention.

FIG. 23 is a table illustrating information managed by the image forming apparatus according to an exemplary embodiment of the present invention.

### DETAILED DESCRIPTION OF THE EMBODIMENTS

Various exemplary embodiments, features, and aspects of the invention will be described in detail below with reference to the drawings.

### First Exemplary Embodiment

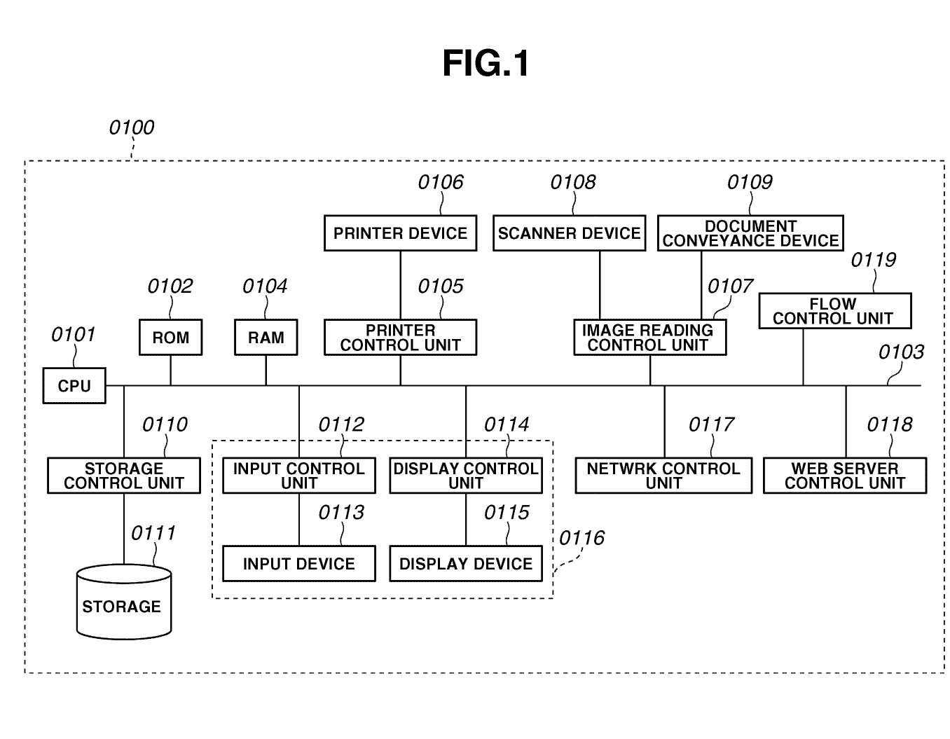

FIG. 1 is a block diagram illustrating an image forming apparatus 0100, such as a digital multifunction peripheral, according to a first exemplary embodiment of the present invention.

A central processing unit (CPU) 0101 is a controller for controlling the image forming apparatus 0100.

The CPU 0101 boots an operating system (OS) by a boot program stored in a read-only memory (ROM) 0102. The CPU 0101 executes controller programs and various application programs, which are stored in a storage 0111, on the OS.

The CPU 0101 is coupled to each constituent portion through buses, such as a data bus 0103.

A random access memory (RAM) 0104 operates as a main memory and a temporary storage area, such as a work area, for the CPU 0101. When image data is converted, the RAM 0104 is used as a temporary data storage area.

A printer control unit 0105 prints image data on a sheet of paper or the like by controlling a printer device 0106. The printer control unit 0105 can be, for example, of the electrophotographic printing type using a photosensitive drum or belt, or of the inkjet type that prints an image directly on a sheet of paper by discharging ink from a micro-nozzle array. However, any type of the printer control unit 0105 can be used.

An image reading control unit 0107 acquires image data by controlling a scanner device 0108. The image reading control unit 0107 controls a document conveyance device 0109, such as an automatic document feeder (ADF), and generates image data by conveying a document placed on a document positioning plate of the document conveyance device 0109 to the scanner device 0108 sheet by sheet.

A scanner device 0108 scans paper using an optical reading device, such as a charge-coupled device (CCD), and converts image information representing a document into electric signal data. The scanner device 0108 and the document conveyance device 0109 have a document detecting sensor and a document size detecting sensor. The document detecting sensor and the document size detecting sensor can detect the presence/absence of a document and the size of a document, respectively. A document detecting method is, for example, to detect the presence/absence or the size of a document at prescan. Alternatively, another document detecting method can be used.

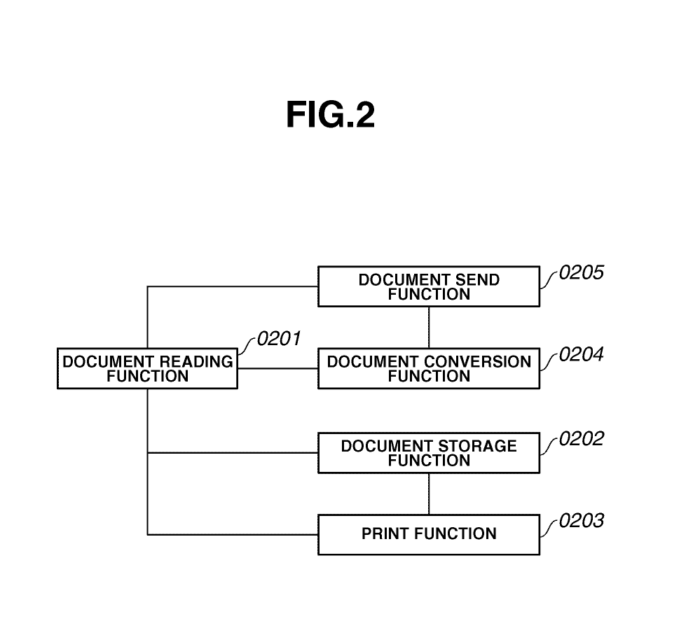

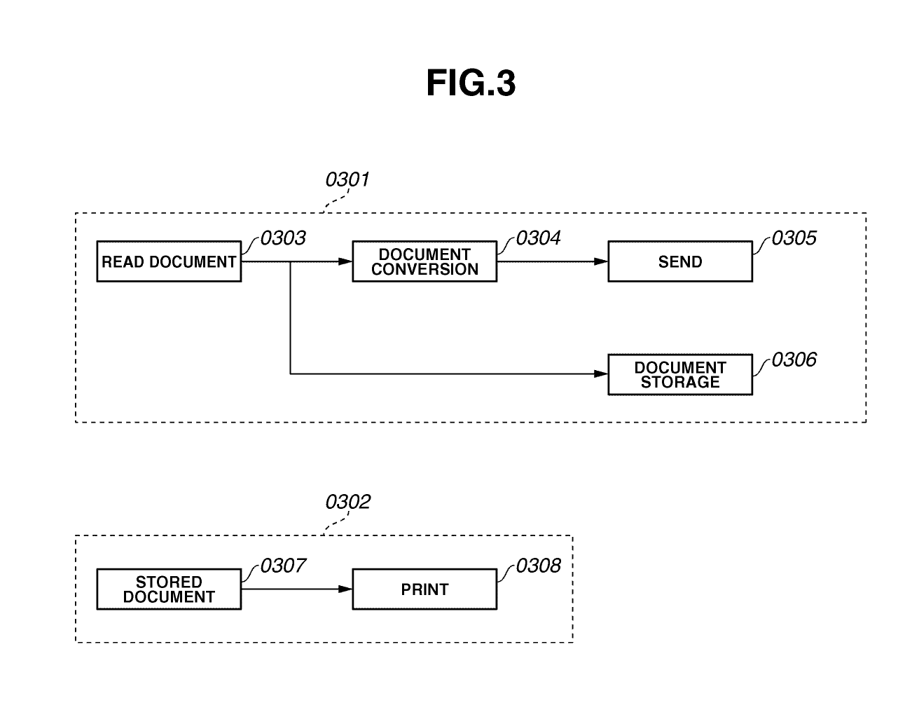

The storage 0111 is a nonvolatile memory, such as HDD, from which data can be read, and to which data can be written. Controller programs for controlling the entire system, various application programs, and various data such as image data representing scanned images are stored in the storage 0111. Information representing processing flows managed by the image forming apparatus 0100 is stored in the storage 0111. An example of this operation will be described below with reference to FIGS. 2 and 3. A storage control unit 0110 controls the storage 0111.

An input control unit 0112 receives a user's operation instruction from an input device 0113, such as a touch panel or a hard key. A display control unit 0114 controls a display device 0115, such as a liquid crystal display (LCD) or a cathode ray tube (CDT), to display an operation screen.

The input control unit 0112, the input device 0113, the display control unit 0114, and the display device 0115 constitute an operation unit 0116.

A network control unit 0117 controls a network, such as a local area network (LAN) or a telephone circuit, to transmit or receive various data, such as image data, using FAX and e-mail.

A web server control unit 0118 is a web server provided in the image forming apparatus 0100 and provides a web page for remotely controlling the image forming apparatus 0100. When receiving a page request from an external apparatus via the network control unit 0117, the web server control unit 0118 reads and transmits hyper text markup language (HTML) data or image data, which is stored in the storage 0111 and corresponds to the requested page.

A flow control unit 0119 executes, for example, a processing flow registered in the image forming apparatus 0100, which will be described below with reference to FIG. 3, using each module of the image forming apparatus 0100. The flow control unit 0119 generates a new flow and edits a previously generated flow.

FIG. 2 is a functional block diagram illustrating functions of the image forming apparatus 0100 implemented by constituent elements illustrated in FIG. 1.

A document reading function 0201 is implemented by the image reading control unit 0107, the scanner device 0108, the document conveyance device 0109. The document reading function 0201 is configured to read a document to generate document data.

A document storage function 0202 is implemented by the storage control unit 0110 and the storage 0111 and is configured to store document data generated by the document reading function 0201.

A print function 0203 is implemented by the printer control unit 0105 and the printer device 0106. The print function 0203 is configured to print document data generated by the original reading function 0201 or stored by the document storage function 0202.

A document conversion function 0204 is implemented by the CPU 0101 and the RAM 0104 and is configured to convert document data generated by the document reading function 0201 into document data of another format, such as a portable document format (PDF).

A document send function 0205 is implemented by the network control unit 0117. The document send function 0205 is configured to send, to an external device on a network, document data generated by the document reading function 0201, document data stored by the document storage function 0202, or document data generated by the document conversion function 0204.

Next, cases in which processing performed by the present embodiment is effective are described below so as to exemplify the present embodiment.

In such a case, the following operation is performed at a counter as an application accepting operation. First, information written on an application form by a customer is checked. Subsequently, the information is read using the document reading function 0201. The information read from the application form is sent to a department in charge so as to pass the read inform thereto, using the document send function 0205.

In another case, information written on an application form by a customer for custody is stored by the document storage function 0202 for a certain period.

In a still another case, the following operation is performed at a counter as an application printing operation. When the number of remaining copies of an application form placed at the counter is small, document data representing an application form that is stored in the document storage function 0202 is printed so as to replenish application forms.

FIG. 3 illustrates an outline of a processing flow executed at the counter as an office counter work. A processing flow (hereinafter referred to as a work flow or simply as a flow) includes a plurality of processing steps, as illustrated in FIG. 3.

A processing flow 0301 is an application accepting flow representing an operation of accepting an application form in which information is filled by a customer.

A document reading step 0303 is a step of reading a document (i.e., an application form in which information is filled by a customer) by the document reading function 0201 to generate document data.

A document conversion step 0304 is a step of converting the document data generated in the document reading step 0303 into a PDF file.

A send step 0305 is a step of sending the PDF file, into which the document data is converted in the document conversion step 0304, to an external server using an e-mail message.

A document storage step 0306 is a step of storing, in a storage area “Box” in the image forming apparatus 0100, the document data generated in the document reading step 0303.

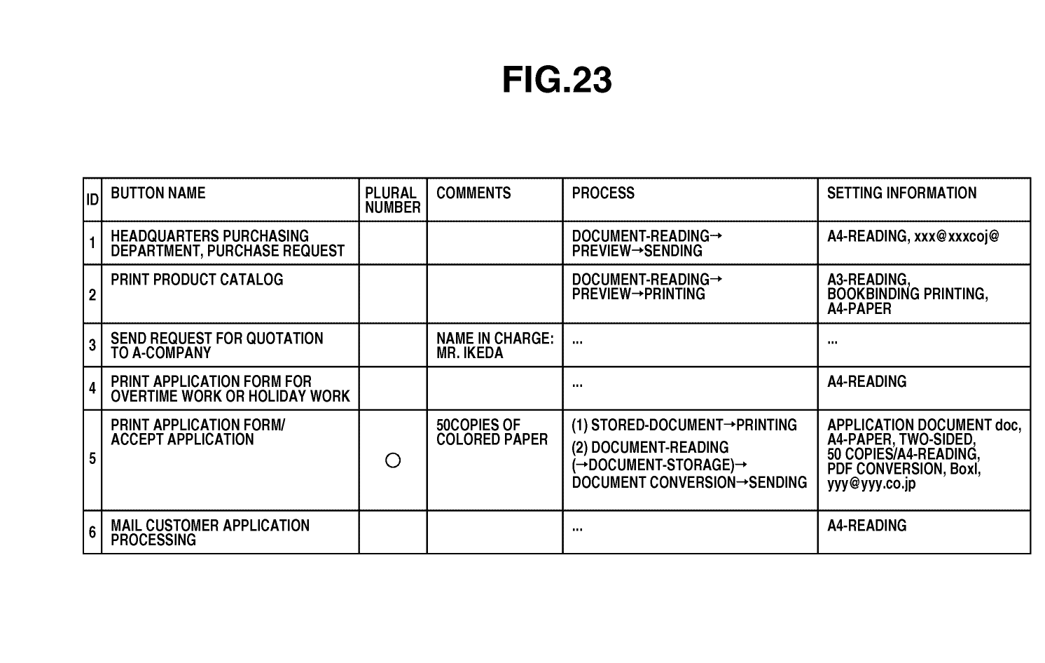

In the document reading step 0303, document reading setting information representing various conditions, such as a document size of A4 and two-sided reading, is set. In the send step 0305, sending information representing a mail address of a destination, to which the file is sent, is set. In the document storage step 0306, information representing a location, at which the document data is stored, is set. These kinds of information are managed according to a “setting information” item illustrated in FIG. 23.

Meanwhile, a flow 0302 illustrated in FIG. 3 is an “application form (format) printing flow” corresponding to an operation of printing an application form (format), in which information is to be filled by a customer.

A stored document step 0307 is a step of acquiring document data (i.e., an application format) stored by the document storage function 0202 from the storage 0111.

A print step 0308 is a step of printing the document data, which is acquired in the stored document step 0307, by the print function 0203. In the stored document step 0307, storage information, which indicates that the document data to be printed is stored, is set. In the print step 0308, print setting information (e.g., a document size of A4, two-sided printing, and 50 copies) is set.

Hereinafter, the present embodiment is described according to an example illustrated in FIG. 3. FIG. 3 illustrates only an example of a case to which the present embodiment can be applied. Processing according to the present embodiment can be applied to a case different from the case illustrated in FIG. 3.

The registration, setting, and execution of flows 0301 and 0302 illustrated in FIG. 3 are described below.

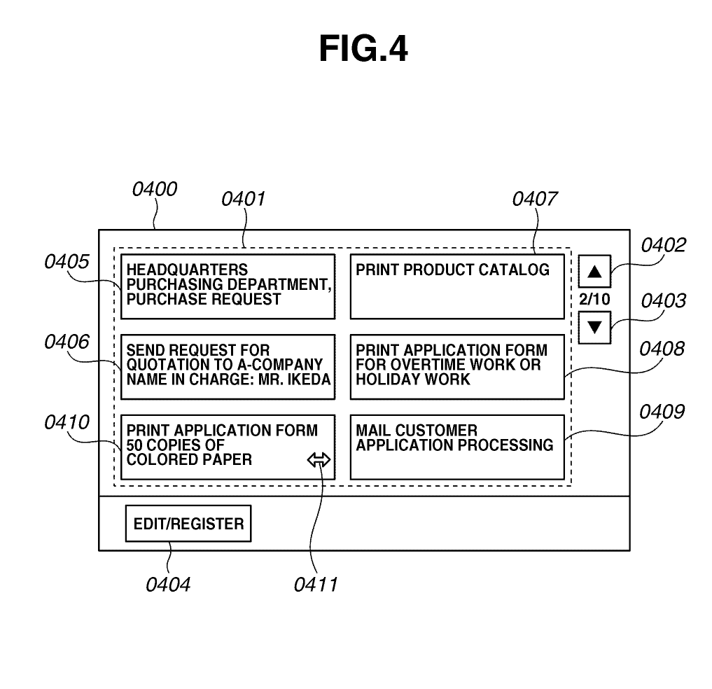

FIG. 4 illustrates an operation screen (i.e., a screen 0400) displayed in the display device 0115 of the operation unit 0116. Buttons displayed on the screen can be operated via the input device 0113, which is a touch panel.

A flow button display area 0401 is an area on which buttons associated with processing flows managed by the image forming apparatus 0100 are displayed. In an embodiment, each button is used as a flow execution designation unit and is called “a flow button” (also referred to herein as “a designation portion”). The image forming apparatus 0100 can execute a flow associated with a flow button that is designated (selected) by a user. The name of an associated flow and an optional comment indicating the associated flow are displayed on each flow button. Thus, each flow can be discriminated from other flows.

Scroll buttons 0402 and 0403 are used to scroll the flow button display area 0401. The scroll buttons 0402 and 0403 can be used in a case where not all of the flow buttons can be displayed on one page.

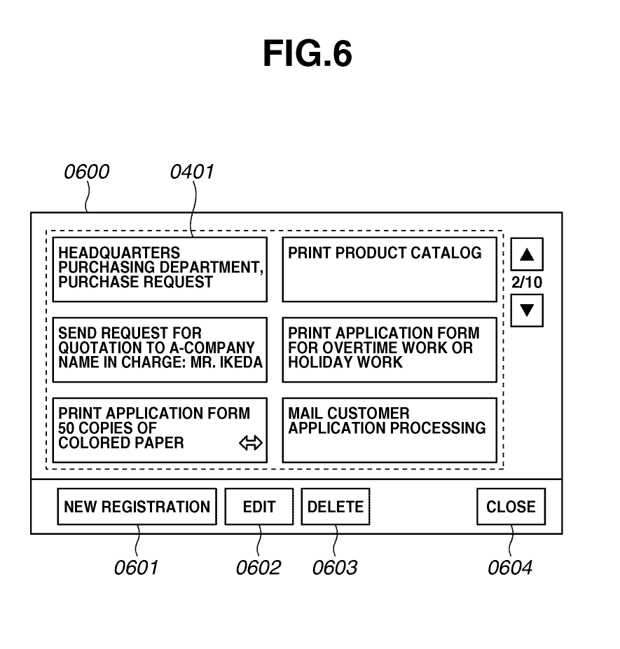

An edit/register button 0404 is used when registering a flow or when editing a registered flow. When the edit/register button 0404 is designated (selected), the screen 0400 illustrated in FIG. 4 is changed to a screen 0600 illustrated in FIG. 6.

Flow buttons 0405 to 0409 are associated with respective user-defined flows.

A flow button 0410 is associated with two flows 0301 and 0302 illustrated in FIG. 3.

The flow control unit 0119 can selectively execute a plurality of flows associated with the respective flow buttons by detecting the presence of a document, using the document detecting function of the scanner device 0108 or the document conveyance device 0109.

A mark 0411 displayed on the flow button 0410 indicates that a flow to be executed is switched according to the presence/absence of a document. FIG. 4 illustrates an example of a display in a case where no document is detected. The case, in which the scanner device 0108 or the document conveyance device 0109 detects no document, means that a flow requested by a user does not need to read a document. Thus, the display control unit 0114 displays a flow 0302 (i.e., “application form printing” flow), which does not need to read a document, from among two flows associated with the flow button 0410. Consequently, the name of the flow 0302 and an associated comment are displayed on the flow button 0410. When the flow button 0410 is designated (selected) in the state illustrated in FIG. 4, the flow control unit 0119 executes the flow 0302.

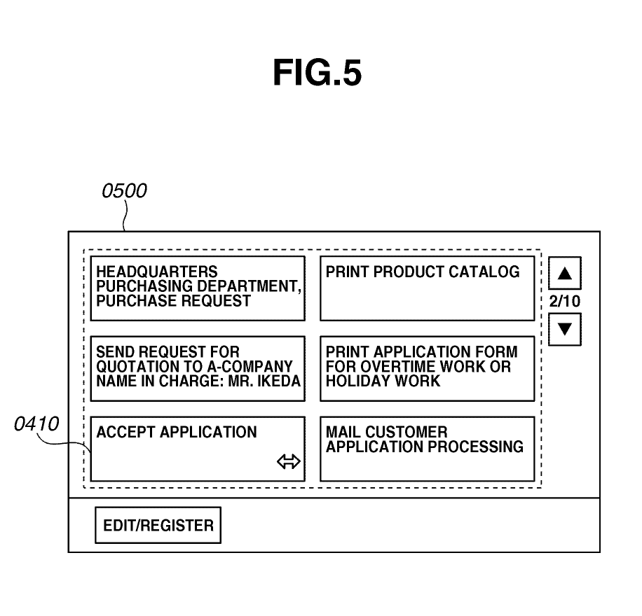

FIG. 5 illustrates an example of an operation screen (i.e., a screen 0500) in a case where a document is placed on the scanner device 0108 or the document conveyance device 0109.

In the state illustrated in FIG. 5, a document is detected. Thus, it is considered that the flow requested by a user needs to read a document. Therefore, the display control unit 0114 displays the flow 0301 (i.e., an “application accepting” flow), which needs to read a document, from among two flows associated with the flow button 0410. Consequently, the name of the flow 0301 and an associated comment are displayed on the flow button 0410. When the flow button 0410 is designated (selected) in the state illustrated in FIG. 5, the flow control unit 0119 executes the flow 0301.

FIG. 6 illustrates an example of an operation screen (i.e., a screen 0600) displayed in a case where the edit/register button 0404 illustrated in FIG. 4 is designated (selected).

A user can newly register a flow or edit a registered flow via the screen 0600. An indication displayed in an upper part of the screen 0600 is similar to that displayed on the screen 0400. Even when each flow button is designated (selected) in the state illustrated in FIG. 6, the flow control unit 0119 does not start the flow. In a case where each flow button is designated (selected) in the state illustrated in FIG. 6, the designated flow button is highlighted. The designated flow button is thus put into a selected state.

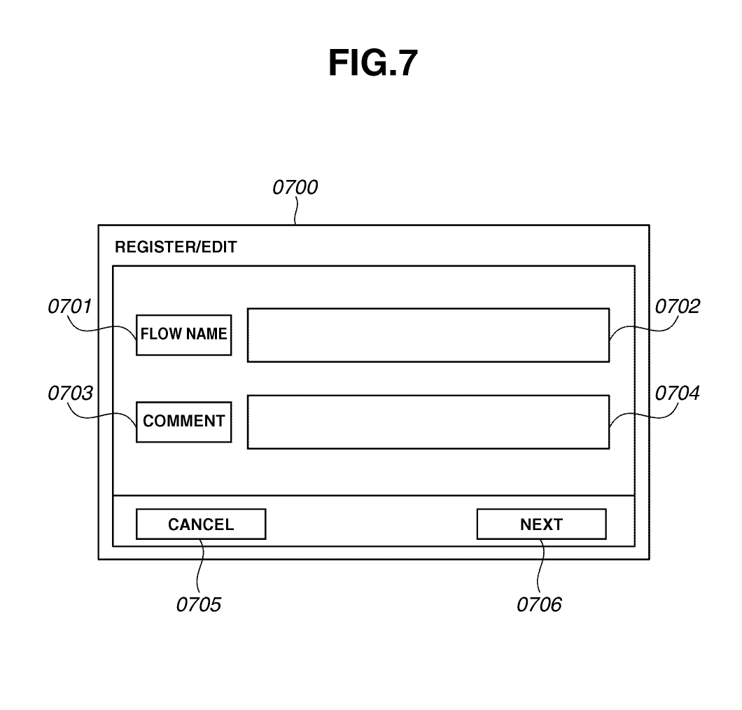

A new registration button 0601 is used when a flow is newly registered. When the new registration button 0601 is designated (selected), the screen 0600 is changed to a screen 0700 illustrated in FIG. 7.

In a case where no flow button is selected when the new registration button 0601 is designated (selected), a flow button is newly created. A flow set corresponding to this flow button by a user is associated with this flow button.

On the other hand, in a case where a flow button is selected when the new registration button 0601 is designated (selected), a second flow is registered, which changes, according to the presence/absence of a document, a flow to be executed. That is, the flow control unit 0119 associates a newly generated flow with the flow button in a state in which a flow button is selected. Thus, two flows are registered corresponding to the flow button.

In a case where a combination of a flow button, which is currently selected, and a flow to be newly registered is not a combination of a flow, which needs to read a document, and a flow that does not need to read a document, the flow control unit 0119 does not associate a flow, which is generated to be newly registered, with the flow button.

An edit button 0602 is selected when an existing flow is edited. When the edit button 0602 is designated (selected), the currently displayed screen is changed to a screen 0700 illustrated in FIG. 7. Then, a flow corresponding to a flow button selected in the flow button display area 0401 can be edited. In a case where there is no flow button, which is in a selected state, in the flow button display area 0401, the edit button 0602 is in a disabled state and cannot be designated (selected).

A delete button 0603 is used when an existing flow is deleted. The flow control unit 0119 deletes the flow selected in the flow button display area 0401. In a case where no flow button is in a selected state in the flow button display area 0401, the delete button 0603 is in a disabled state and cannot be designated (selected).

In a case where a plurality of flows are registered corresponding to the selected flow button, the flow control unit 0119 can delete the plurality of flows registered corresponding to this flow button in response to designation of the delete button 0603 at once. Alternatively, the flow control unit 0119 can delete the plurality of registered flows one by one.

A close button 0604 is used when a currently displayed screen is closed or is changed to the screen 0400 or 0500.

FIG. 7 illustrates an example of an operation screen 0700 via which the name of a flow and an associated comment can be entered during the registration or editing of the flow.

A flow name button 0701 and a flow name text field 0702 are used when an optional name is entered corresponding to a flow. When the flow name button 0701 is designated (selected), the flow control unit 0119 instructs the display control unit 114 to display a software keyboard (not illustrated) on the display device 116 and registers characters entered via the software keyboard.

In the case of designating a comment button 0703 and a comment text field 0704, similarly, the software keyboard is displayed when designated by a user, and an optional comment can be entered.

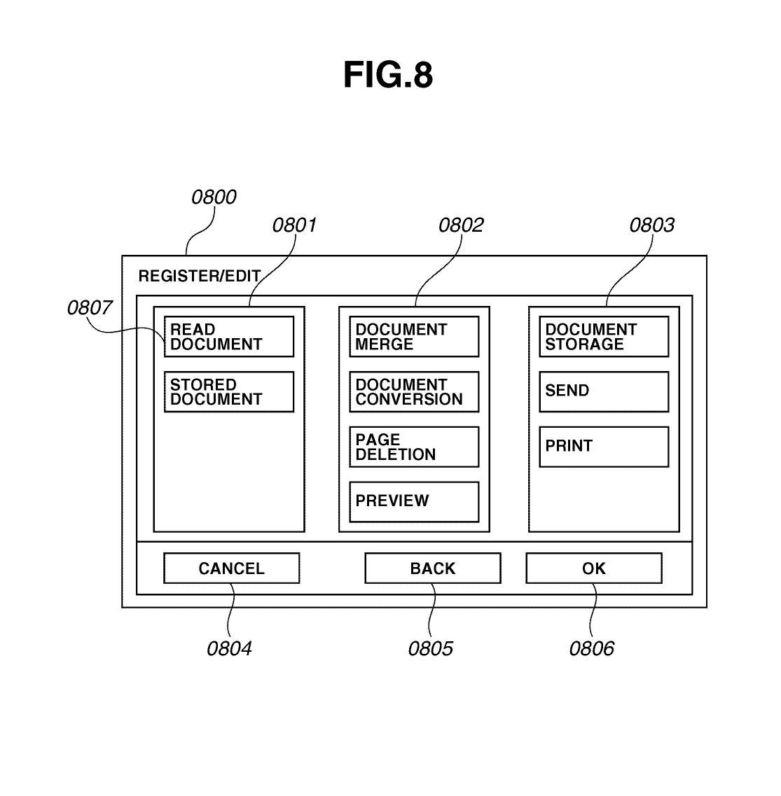

A cancel button 0705 is used when the user desires to cancel the setting entered via the operation screen 0700. When the cancel button 0705 is selected by the user, the currently displayed screen 0700 is changed to the screen 0600 (shown in FIG. 6). A next button 0706 is used when the user desires to change the currently displayed screen 0700 to a screen 0800 illustrated in FIG. 8 to edit information representing an operation corresponding to a flow.

In a case where the edit button 0602 is designated (selected) in the screen 0600, the name of the previously registered flow and an associated comment are displayed in the flow name text field 0702 and the comment text field 0704, respectively.

FIG. 8 illustrates an example of an operation screen 0800 used for the registration or editing of a flow.

The screen 0800 is divided into an input selection portion 0801, an editing selection portion 0802, and an output selection portion 0803.

The input selection portion 0801 is an area for selecting processing to be performed in an input step. In the input selection portion 0801, for example, the “document reading” step and the “stored document” step are displayed. The “document reading” step is to read a document by the document reading function 0201. The “stored document” step is to read a document stored by the document storage function 0202.

The editing selection portion 0802 is an area for selecting processing to be performed in the edit step. In the editing selection portion 0802, for example, the “document merge” step, the “document conversion” step, the “page deletion” step, and the “preview” step are displayed. Processing corresponding to each of these steps is performed by the document conversion function 0204 and is to edit an acquired document according to processing selected by the input selection portion 0801.

The “document merge” step is a step of merging a plurality of documents. The “document conversion” step is a step of converting a document into a document of another format, such as PDF. A “page deletion” step is a step of deleting a designated page of a document. The “preview” step is a step of previewing a document.

The output selection portion 0803 is an area for selecting processing to be performed in an output step. For example, the “document storage” step, the “send” step, and the “print” step are displayed in the output selection portion 0803. These steps are steps of outputting a document according to the processing selected by the input selection portion 0801 or the editing selection portion 0802.

The “document storage” step is a step of storing a document by the document storage function 0202. The “send” step is a step of sending a document to a destination designated by the document sending function 0205. The “print” step is a step of printing a document by the printing function 0203.

The flow control unit 0119 generates a processing flow by combining steps selected from the input selection portion 0801, the editing selection portion 0802, and the output selection portion 0803.

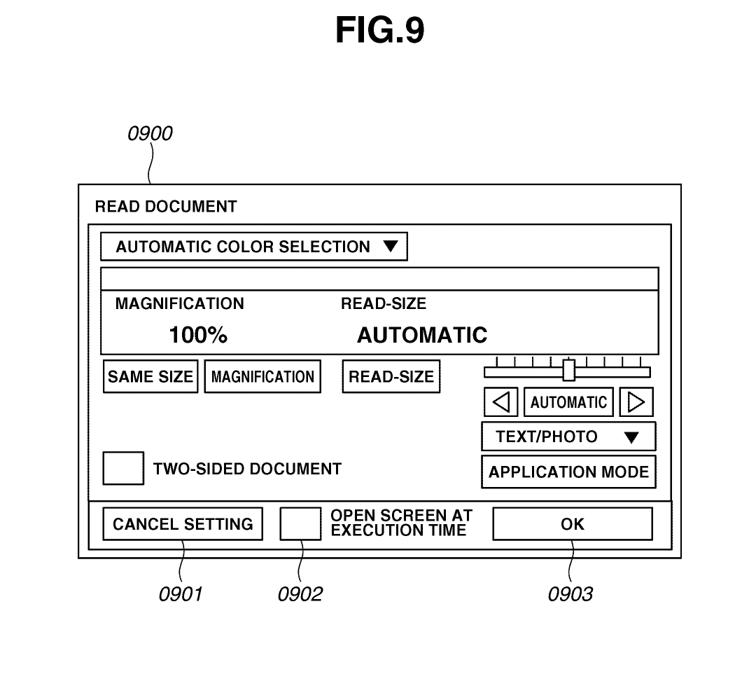

The flow control unit 0119 changes the currently displayed screen to a setting screen, which is used for setting detailed information concerning the step, when a step to be executed is selected by each of the selection portions 0801 to 0803. Although the detailed description of all of the setting screens according to the present embodiment is omitted, FIG. 9 illustrates an example of an operation screen displayed when the document reading step button 0807 representing the document reading step is designated (selected).

The cancel button 0804 included in the operation screen 0800, which is illustrated in FIG. 8, is used when setting information input via the setting screen 0800 is canceled and the currently displayed screen is returned to the screen 0600. A “back” button 0805 is used when the name of a flow and an associated comment are set by changing the currently displayed screen back to the screen 0700.

An “OK” button 0806 is used when information input via the setting screen 0800 is definitely determined.

In a case where the edit button 0602 is designated (selected) on the screen 0600, a button corresponding to the already selected step in the flow to be edited is highlighted.

FIG. 9 illustrates an example of an operation screen 0900 displayed in a case where the document reading step button 0807 is designated (selected). Although the detail description thereof is omitted, information representing the color/monochrome selection, the document size, a reading magnification, designation of a two-sided document, and a reading density can be set as information for setting reading.

A cancel setting button 0901 is used to cancel the setting and selection of the current step and putting the currently displayed screen back to the screen 0800.

A button 0902 for opening a screen at execution is a toggle switch. When the button 0902 is designated (selected), the button 0902 is brought into an ON-state. Then, the button 0902 is highlighted. When designated again, the button 0902 is put into an OFF-state. Then, the highlighting is canceled. In a case where the button 0902 is set in an ON-state, when the document reading step is executed while the flow is executed, the flow control unit 0119 displays the screen 0900 so as to give a user a chance to change and confirm setting.

An “OK” button 0903 is used when the setting in the document reading step is definitely determined and the currently displayed screen is put back to the screen 0800.

FIG. 23 illustrates an example of information stored in the storage 0111, in which the processing flow registered via the screens illustrated in FIGS. 8 and 9 and setting information corresponding to a step included in the registered processing flow are stored.

A “plural number” item illustrated in FIG. 23 is used to manage information for discriminating whether a plurality of processing flows are registered corresponding to one flow button. For example, a white circle is written in the “plural number” item field in a flow button having an ID=5. This indicates that a plurality of processing flows are registered corresponding to this flow button. Thus, the image forming apparatus 0100 can manage a plurality of processing flows as one group, as in the case of the flow button having an ID=5.

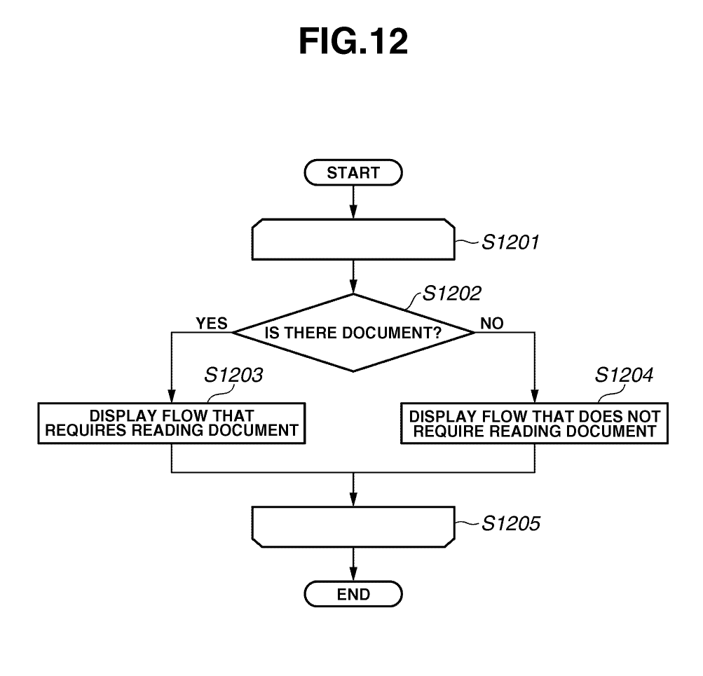

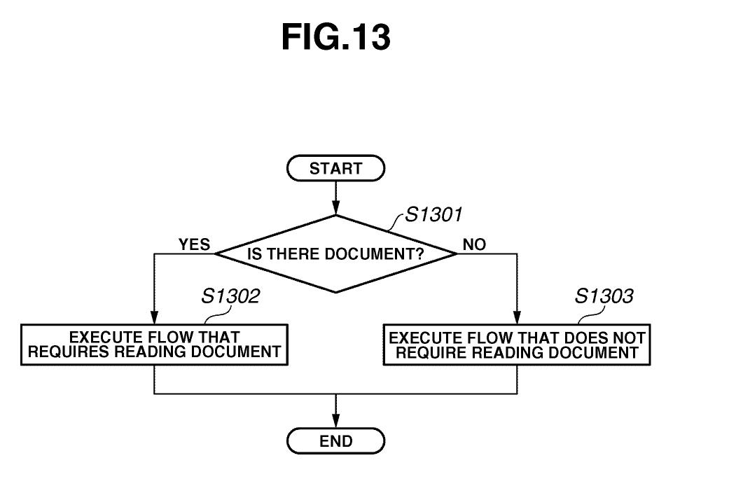

According to the “process” item, a plurality of steps included in each processing flow are managed. According to the “setting information” item, information for setting processing in each of processing steps is managed. The flow control unit 0119 executes a process, which will be described below (by referring to FIGS. 12 and 13), using information stored in the storage 0111, which is illustrated in FIG. 23.

In the case of the button whose ID=5, the application form printing flow is associated with information (1) in the process item and setting information written in front of “/” in the setting information item field (i.e., an application document.doc, A4-paper, two-sided, 50 copies). On the other hand, the application accepting flow is associated with information (2) in the process item and setting information written behind “/” in the setting information item field (i.e., A4-reading, PDF conversion, Box1, yyy@yyy.co.jp).

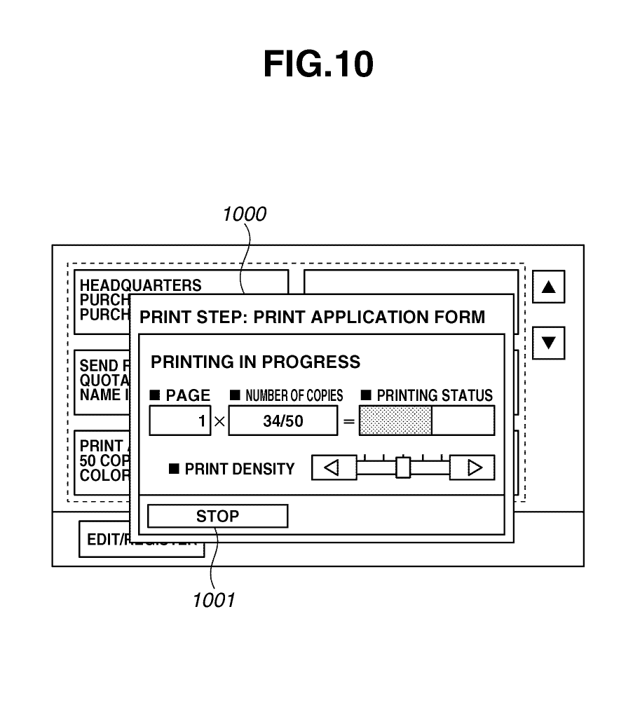

FIG. 10 illustrates an example of a screen displayed by executing the flow corresponding to the flow button 0410 in a case where the flow button 0410 is designated (selected) in the screen 0400.

The screen 0400 illustrated in FIG. 4 indicates a case where no document is detected. The flow control unit 0119 executes the flow 0302 (i.e., the application form printing flow), which does not need to read a document. Although detailed description is omitted, a screen 1000 indicates a state in which the print step 0308 of the flow 0302 is executed. When the print step 0308 is finished, the currently displayed screen is automatically put back to the screen 0400. A stop button 1001 is used for instructing to stop the execution of the flow. In the stored document step 0307, an operation screen is not displayed because an associated execution time is short.

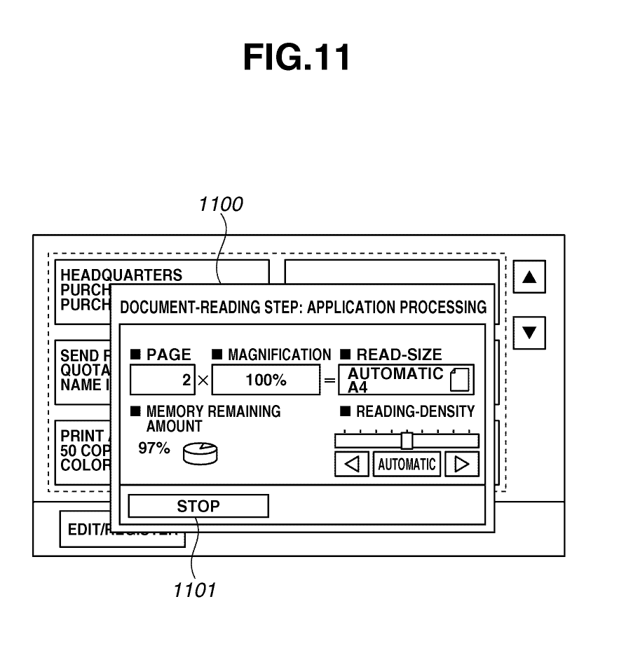

FIG. 11 illustrates a screen displayed by executing the flow corresponding to the flow button 0410 in a case where the flow button 0410 is designated (selected) in the screen 0500 illustrated in FIG. 5.

The screen 0500 illustrated in FIG. 5 indicates a case where a document is detected. Thus, the flow control unit 0119 executes the flow 0301 (i.e., the application accepting flow), which needs to read a document. Although detailed description is omitted, the screen 1100 indicates a state in which the document reading step 0303 of the flow 0301 is executed. When the document reading step 0303 is finished, the screen 1100 is automatically closed. Then, the screens (not illustrated) indicating the execution states of the document conversion step 0304, the sending step 0305, the document storage step 0306 are serially displayed. Upon completion of executing the flow 0301, the currently displayed screen is automatically put back to the screen 0400. The stop button 1101 is used for instructing to stop the execution of the flow.

Next, the procedures for the flow displaying processing and the flow executing processing according to the present embodiment are described below.

FIG. 12 is a flowchart for determining a flow to be displayed from among a plurality of flows associated with a flow button.

The flow control unit 0119 iteratively executes steps S1201 to S1205 corresponding to a flow button, with which a plurality of flows are associated.

In step S1202, the flow control unit 0119 determines whether a document is present according to a result of detection performed by the scanner device 0108 or the document conveyance device 0109.

If it is determined in step S1202 that a document is present (YES in step S1202), then in step S1203, the flow control unit 0119 displays a flow that needs to read a document. More specifically, information set by using the screens illustrated in FIGS. 4 to 9 is stored in the storage 0111 serving as a storage area. Thus, the flow control unit 0119 accesses the storage 0111 and analyzes steps of the processing flows with which a button is associated. Then, the flow control unit 0119 displays a processing flow that needs to read a document.

In contrast, if it is determined in step S1202 that no document is present (NO in step S1202), then in step S1204, the flow control unit 0119 displays a flow that does not need to read a document.

As described above, the image forming apparatus 0100 can change the display of a flow button corresponding to a group with which a plurality of processing flows are managed, according to a result of detection of a document.

Thus, even in the case of a flow button with which a plurality of flows are registered, a flow to be expected to be selected by a user as processing to be next performed is displayed. Consequently, the user can select a flow button without being confused. Consequently, a user can be prevented from performing an erroneous operation, that is, executing an erroneous processing flow.

FIG. 13 is a flowchart illustrating a process of selecting a processing flow to be executed according to a result of detection of a document when designating a flow button corresponding to one group with which a plurality of processing flows managed by the image forming apparatus 0100 are registered.

In step S1301, the flow control unit 0119 determines whether a document is present according to a result of detection by the scanner device 0108 or the document conveyance device 0109.

In a case where it is determined in step S1301 that a document is present (YES in step S1301), then in step S1302, the flow control unit 0119 executes a flow that needs to read a document. More specifically, information set by using the screens illustrated in FIGS. 4 to 9 is stored in the storage 0111 serving as a storage area. Thus, the flow control unit 0119 accesses the storage 0111 and analyzes steps of the processing flows with which a button is associated. Then, the flow control unit 0119 displays a processing flow that needs to read a document. The flow control unit 0119 instructs a control unit, which executes a first step included in this flow, to start processing. For example, in a case where the first step is a document reading step, the flow control unit 0119 instructs the image reading control unit 0107 to start reading a document.

On the other hand, if it is determined in step S1301 that no document is present (NO in step S1301), then in step S1303, the flow control unit 0119 executes a flow that does not need to read a document.

As described above, the image forming apparatus 0100 associates a flow that needs to read a document with a flow that does not need to read a document and manages these flows as one group. Then, according to a result of detection of a document, the image forming apparatus 0100 selects a processing flow, which is to be preformed, from among a plurality of processing flows included in one group the execution of which is instructed. Subsequently, the image forming apparatus 0100 serially executes a plurality of steps of the selected processing flow using the function of executing the plurality of steps.

Consequently, two flows can be associated with one flow button. Accordingly, a user's operability can be prevented from being deteriorated due to an increase in the number of flow buttons.

Additionally, a flow to be expected to be next executed is executed according to a result of detecting a document. Thus, even in a case where two flows are associated with one flow button, the execution of an appropriate flow can easily be achieved.

### Second Exemplary Embodiment

In the first exemplary embodiment, an example of switching the display of a flow button and the execution of a flow, which is to be executed, has been described. However, in the first exemplary embodiment, a flow button with which a flow expected not to need to input a detected document is registered is also displayed. Thus, in the following description of a second exemplary embodiment of the present invention, a technique of limiting displayed flow buttons to that corresponding to a flow that is expected to be executed next, according to a result of detecting a document is described.

Referring to FIG. 4, a flow of an operation of reading a document having a size of A4 is assumed to be set corresponding to each of flow buttons 0408 and 0409. The size of an application form to be read in the flow 0301 is assumed A4. Flows set corresponding to the flow buttons, which include those scrolled by scroll buttons 0402 and 0403, do not need to input a document having a size of A4 or do not need to read a document.

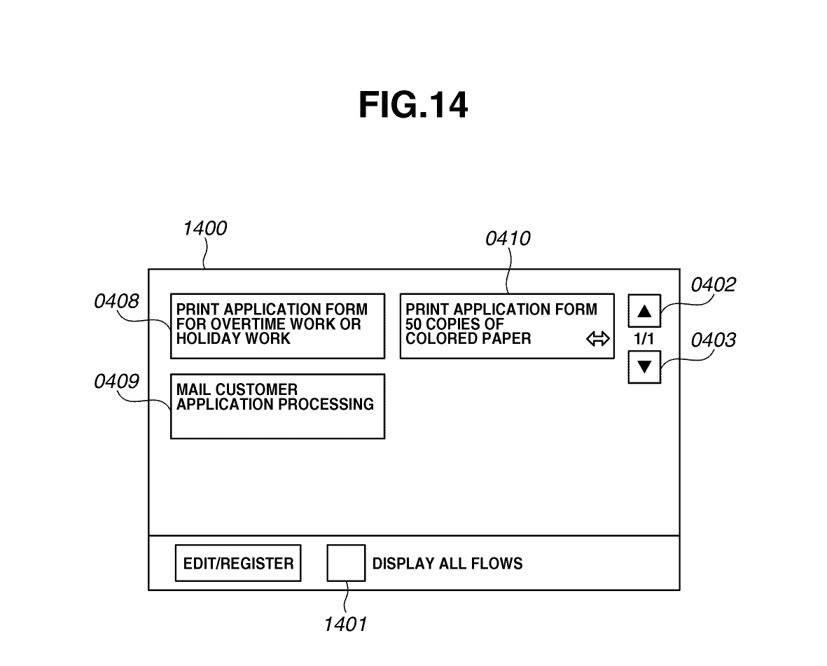

FIG. 14 illustrates a screen 1400 displayed and changed from the screen 0400 (corresponding to a state in which no document is detected) in a case where the scanner device 0108 or the document conveyance device 0109 detects a A4-sized document. Thus, according to a result of detecting a document, the flow control unit 0119 instructs the display control unit 0114 to display a flow button with which a flow that needs to read a document is registered.

A display-all-flows button 1401 is a button of the toggle type for displaying all flow buttons regardless of whether flows need to read a document having a size of A4. The display-all-flows button 1401 is used when a flow to be used is selected regardless of the size of a document, for example, in a case where displayed information is changed.

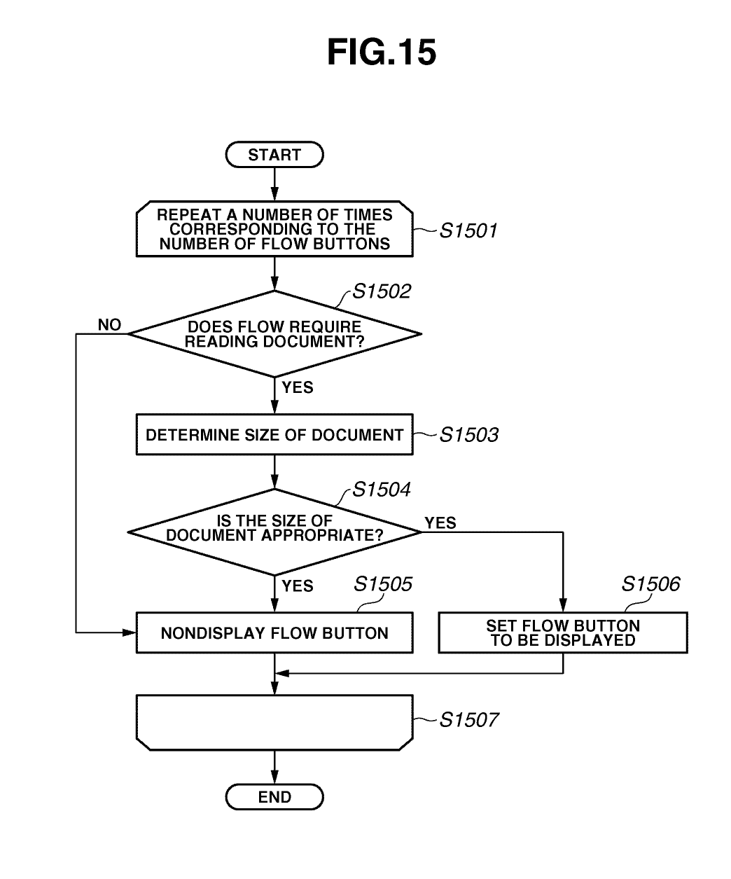

Next, a flow of an operation of determining a flow button, which is to be displayed, according to a result of detecting a document is described below with reference to FIG. 15.

Processing to be performed in each of steps (S1501 to S1507) illustrated in FIG. 15 is repeated a number of times corresponding to the number of registered flow buttons.

In step S1502, the flow control unit 0119 specifies a first flow button as a target flow button and determines whether a flow set corresponding to the target flow button needs to read a document.

If it is determined in step S1502 that a flow required to read a document is set (YES in step S1502), then in step S1503, the flow control unit 0119 determines the size of a document detected by the scanner device 0108 or the document conveyance device 0109.

Subsequently, the flow control unit 0119 acquires a document reading size set in a document reading step of the flow corresponding to the target flow button. The reading size set in the document reading step using the screen illustrated in FIG. 9 is stored in the storage 0111. Thus, the flow control unit 0119 can acquire the document reading size, which is used in the document reading step of the flow corresponding to the flow button, from the storage 0111.

Then, in step S1504, the flow control unit 0119 compares the document reading size acquired from the storage 0111 with the size of the document determined in step S1503 so as to determine whether the size of the document is appropriate. For example, in a case where a result of detecting a document determined in step S1503 indicates that the size of the document is A4, the flow control unit 0119 determines in step S1504 that the size of the document is appropriate (YES in step S1504), if the document reading size set in the document reading step of the processing flow corresponding to the target flow button is A4. On the other hand, if the document reading size set in the document reading step is not A4, the flow control unit determines in step S1504 that the size of the document is inappropriate (NO in step S1504).

In a case where the flow control unit 0119 determines in step S1502 that the flow does not need to read a document, or in step S1504 that the size of the document is inappropriate, then in step S1505, the flow control unit 0119 sets the target flow button to be non-displayed.

On the other hand, in a case where the flow control unit 0119 determines in step S1502 that the flow needs to read a document, or in step S1504 that the size of the document is appropriate, then in step S1506, the flow control unit 0119 sets the target flow button to be displayed.

Thus, the image forming apparatus 0100 displays the processing flows, each of which has a step of reading a document having a size equal to that of the detected document, and the processing flows, each of which does not have a step of reading a document having a size equal to that of the detected document, so that the former type of the processing flows can be discriminated from the latter type of the processing flows.

Consequently, the flow buttons to be displayed on the screen are limited to those set corresponding to the processing flows that are expected to be executed next. Thus, the present exemplary embodiment can obtain advantages in easily finding a target flow button.

According to the above-described flowchart, a target flow button set corresponding to a flow that does not need to read a document or a target flow button in a case where the size of a document detected in step S1503 is determined to be inappropriate as the document reading size is set to be non-displayed. However, the image forming apparatus 0100 can be configured such that such a flow button cannot be selected, instead of being set to be non-displayed. Alternatively, a flow button specified in step S1506 as a target to be displayed can be displayed in a manner distinguishable from a flow button that is not specified as a target to be displayed.

### Third Exemplary Embodiment

In a third exemplary embodiment of the present invention, a case of deleting a flow and a case of storing a flow in an external information apparatus or a storage for the purpose of back-up thereof are described.

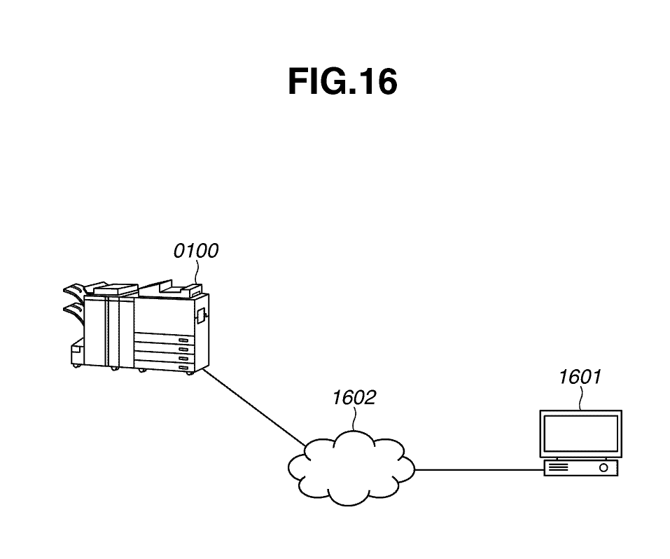

FIG. 16 illustrates a configuration of an information processing system including an image forming apparatus 0100. In the information processing system, the image forming apparatus 0100 is connected to a client personal computer (PC) 1601 serving as an information processing apparatus via a network 1602.

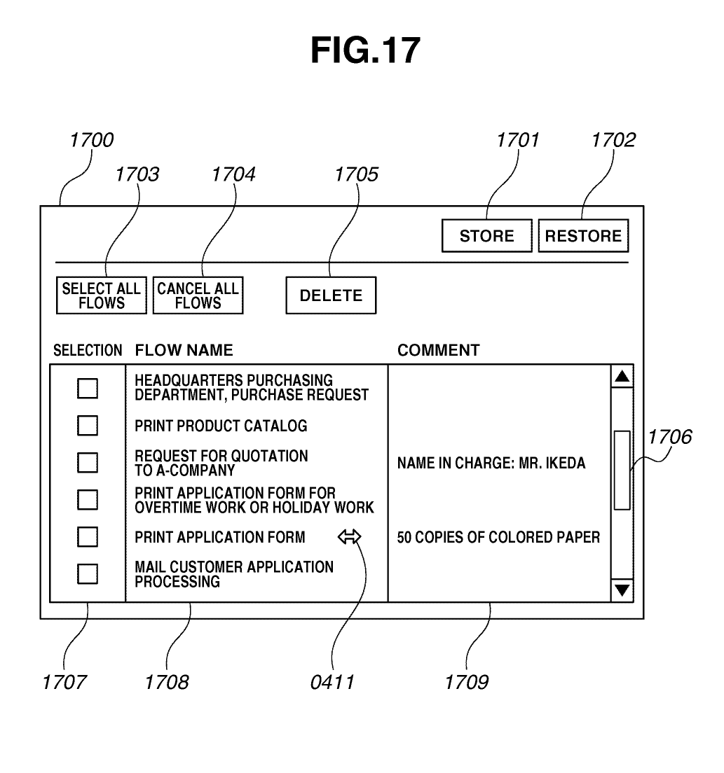

FIG. 17 illustrates an operation screen 1700 displayed on the client PC 1601 when the image forming apparatus 0100 is remotely operated from the client PC 1601 via the web server control unit 0118 of the image forming apparatus 0100.

A store button 1701 is used when a flow is stored in the PC 1601 to be used for back-up. A flow selected by checking a check box of a selection column 1707 and assigned thereto is a target to be stored. In a case where a flow with a mark 0411 is selected as a target to be stored, both of a flows that has a step that needs to read a document and a flow that has a step that does not need to read a document, included in the selected flow, are targets to be stored.

A restore button 1702 is used for restoring the backup data in the image forming apparatus 0100 according to the backup flow stored in the client PC 1601 by the store button 1701. More specifically, when storing a flow, the client PC 160 associates information indicating an image forming apparatus, from which the flow is acquired, with a target flow. Thus, a restoring process can be implemented by informing an image forming apparatus, which is associated with the flow to be restored, of the flow selected as an object to be restored.

A select-all-flows button 1703 is used for selecting all of the flows. Thus, all of the check boxes of the selection column 1707 can be checked to be in a selected state. A cancel-all-flows button 1704 is used for canceling the selection of all of the flows. A delete button 1705 is used for deleting the selected flow. A scroll bar 1706 is used for scrolling the screen. The selection column 1707 is used for selecting a flow.

The name of each flow is displayed on a flow name column 1708. In a case where the flow is changed according to the presence/absence of a document, the name of a flow needing no document is displayed together with the mark 0411. A comment on each of the flows is displayed on a comment column 1709.

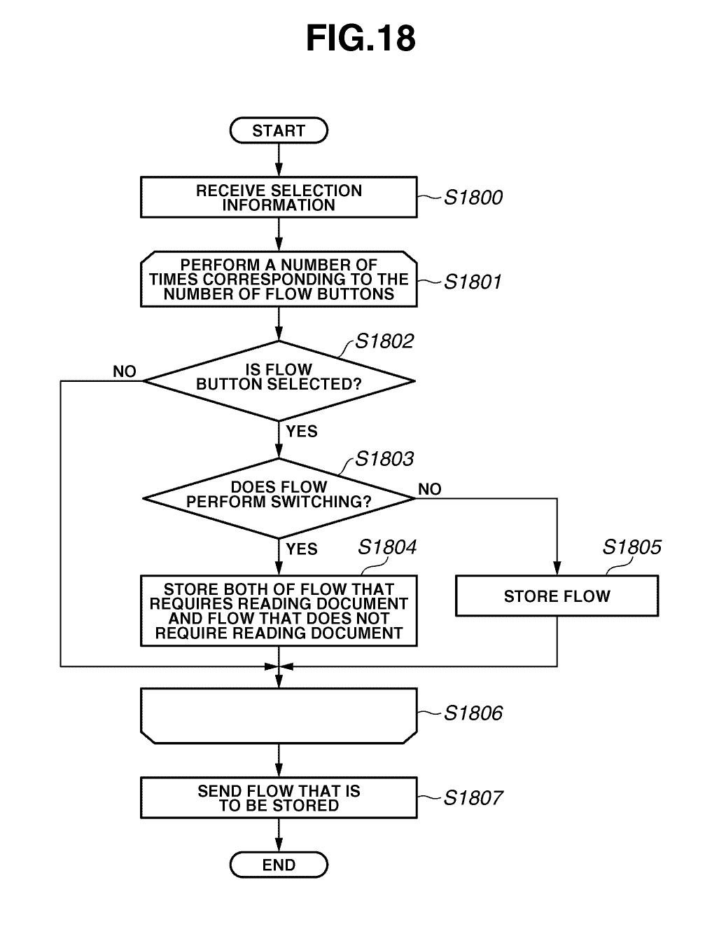

Next, a process performed when a flow is selected as a target storage is described by referring to the flowchart of FIG. 18.

In step S1800, the flow control unit 0119 receives selection information representing a selected flow to be stored via the screen illustrated in FIG. 17. That is, a flow is selected via the operation screen 1700 illustrated in FIG. 17 on the screen of the client PC 1601. When the store button 1701 is designated (selected), the image forming apparatus 0100 is informed of information representing the selected flow.

The flow control unit 0119 repeatedly executes the process having steps S1801 to S1806 a number of times corresponding to the number of registered flow buttons.

In step S1802, the flow control unit 0119 determines whether a first one of the registered flow buttons is selected as a target to be stored according to the selection information received in step S1800. More specifically, the flow name is included in the selection information. Thus, the determination is achieved in step S1802 by comparing the flow name included in the selection information with a flow name to be checked.

In a case where it is determined in step S1802 that the first flow button is selected as a target to be stored (YES in step S1802), then in step S1803, the flow control unit 0119 determines whether the target flow button corresponds to a flow to be switched according to the presence/absence of a document.

If it is determined in step S1803 that the target flow button corresponds to such a flow (YES in step S1803), then in step S1804, the flow control unit 0119 stores both of a flow that has a step that needs to read a document and a flow that has a step that does not need to read a document in the RAM 0104.

On the other hand, if it is determined in step S1803 that the target flow button does not correspond to such a flow (NO in step S1803), then in step S1805, the flow control unit 0119 stores the flow corresponding to the target flow button in the RAM 0104.

The flow control unit 0119 performs processing on all of the registered flow buttons in steps S1802 to S1805. Subsequently, in step S1807, the flow control unit 0119 sends information on the flow corresponding to the target flow button, which has been stored in the RAM 0104, to the PC 1601 having instructed to store the flow.

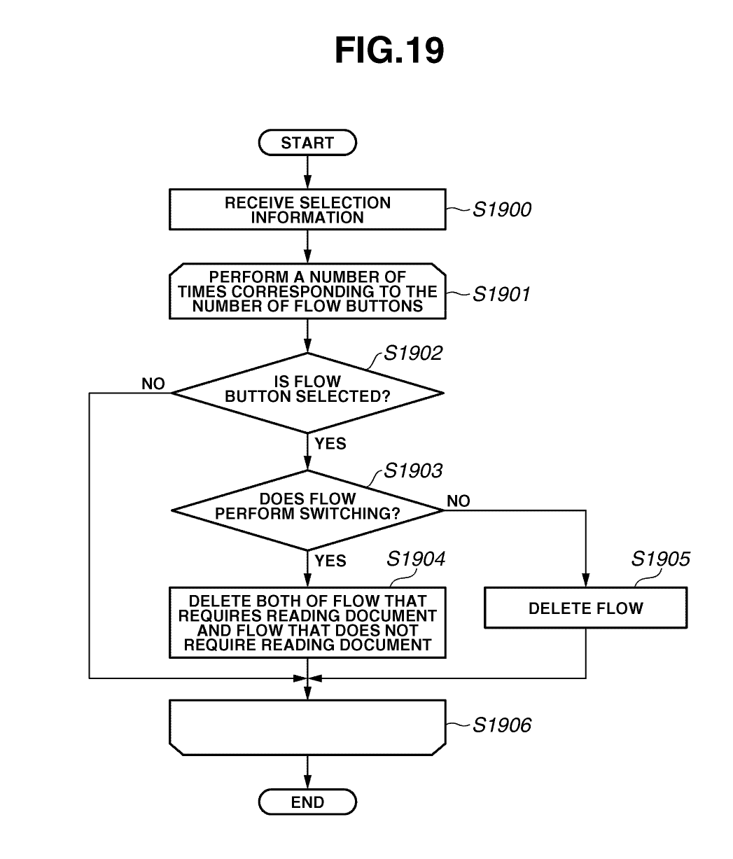

Next, processing to be performed for deleting a flow selected as a target to be deleted is described below with reference to a flowchart illustrated in FIG. 19.

In step S1900, the flow control unit 0119 receives selection information representing a flow selected via the screen 1700 illustrated in FIG. 17. Processing in step S1900 is similar to that in step S1800. Therefore, the detailed description thereof is omitted. However, the difference in processing between steps S1800 and S1900 is that the selection information received in step S1800 instructs to perform storage processing, whereas the selection information received in step S1900 instructs to perform deletion processing.

The flow control unit 0119 repeatedly performs processing in steps S1901 to S1906 a number of times corresponding to the number of registered flow buttons.

In step S1902, the flow control unit 0119 determines whether a first one of the registered flow buttons is selected as a target to be deleted according to the selection information received in step S1900.

In a case where it is determined in step S1902 the first flow button is selected as a target to be deleted (YES in step S1902), then in step S1903, the flow control unit 0119 determines whether the target flow button corresponds to a flow to be switched according to the presence/absence of a document.

If it is determined in step S1903 that the target flow button corresponds to such a flow (YES in step S1903), then in step S1904, the flow control unit 0119 deletes both of a flow that has a step that needs to read a document and a flow that has a step that does not need to read a document.

On the other hand, if it is determined in step S1903 that the target flow button does not correspond to such a flow (NO in step S1903), then in step S1905, the flow control unit 0119 deletes the flow corresponding to the target flow button.

As described above, in a case where flows are changed according to the presence/absence of a document, both of a flow that has a step that needs to read a document and a flow that has a step that does not need to read a document can be stored or deleted at once. Accordingly, a use is not required to individually store or delete two associated flows.

In the description of the third exemplary embodiment, a button is used as a unit instructing the execution of a flow. However, the unit instructing the execution of a flow is not limited to a button. For example, the present exemplary embodiment can be modified such that the registered flows are listed and that a user can select an item representing a user's desired flow to perform a user's desired processing operation.

### Fourth Exemplary Embodiment

In the first to third exemplary embodiments, a processing flow to be executed is changed according to the presence/absence of a document. In the following description of a fourth exemplary embodiment of the present invention, an operation of changing a processing flow, which is to be executed, according to the size of a document detected by a detection sensor (not illustrated) is described below.

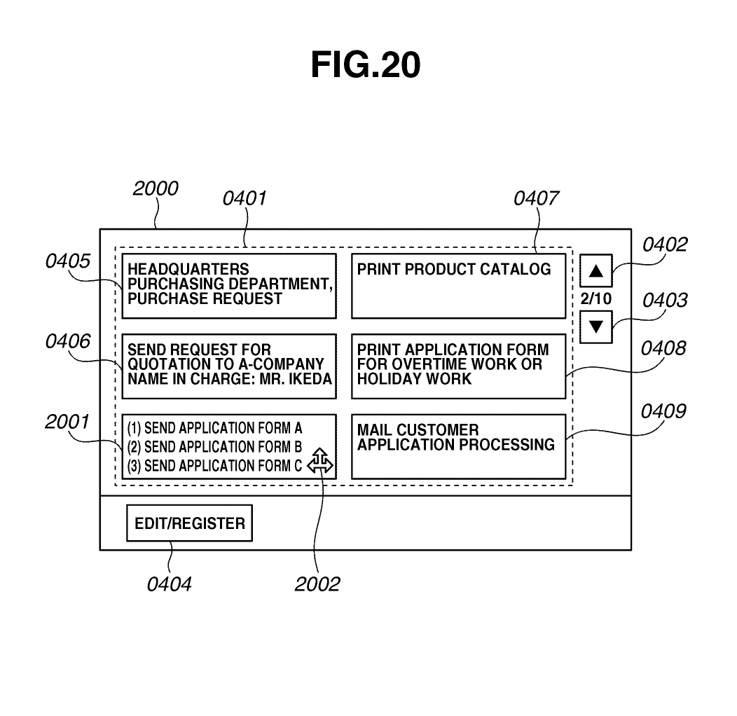

FIG. 20 illustrates an operation screen 2000 displayed in an operation unit of an image forming apparatus according to the present exemplary embodiment. The operation screen according to the present exemplary embodiment is similar to that illustrated in FIG. 4. Thus, only differences between the operation screen and that illustrated in FIG. 4 are described below. FIG. 20 illustrates the operation screen 2000 in a case where no document is detected by the detection sensor. A flow button 2001 indicates that three types of processing flows (1) to (3) a reregistered therewith. Further, a mark 2002 indicating that three types of processing flows are registered is displayed on the flow button 2001. A “send application form A” flow displayed on the flow button 2001 illustrated in FIG. 20 includes an “A4-application-form-A reading” step, a “read-result storing” step, and a “sending-read-result-to-external-office” step. Additionally, a “send application form B” flow and a “send application form C” flow include a “read-result storing” step and a “sending-read-result-to-external-office” step. However, the “send application form B” flow includes an “A3-application-form-B reading” step. The “send application form C” flow includes an “A5-application-form-C reading” step.

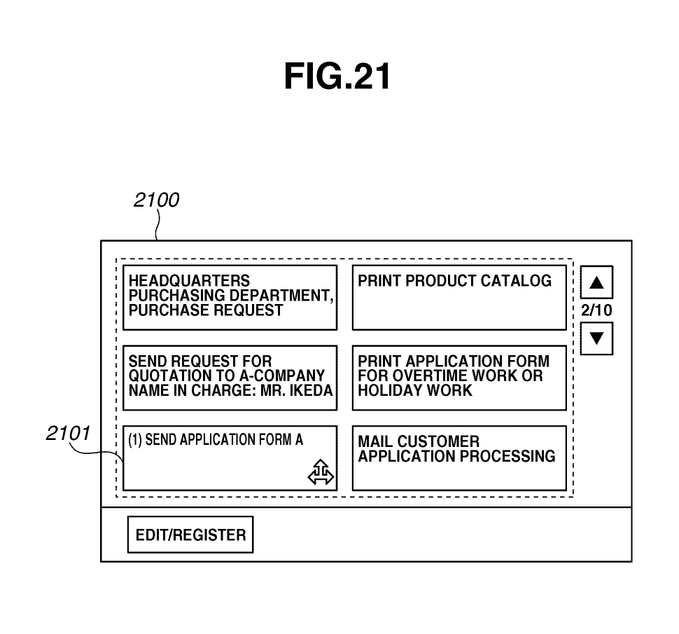

FIG. 21 illustrates a display image of an operation screen 2100 in a case where a document having a size of A4 is detected by the detection sensor.

The flow control unit 0119 displays, on the operation screen 2100 illustrated in FIG. 21, the “send application form A” 2101 flow including the “A4-application-form-A reading” step with respect to the processing flow button, with which three processing flows are registered, in response to a document having a size of A4 being detected by the detection sensor.

Thus, according to the fourth exemplary embodiment, a plurality of processing flows can be registered corresponding to one flow button. Processing flows to be displayed and those to be executed can be selected according to a result of detection of a document by the detection sensor.

When a plurality of processing flows are registered in the present exemplary embodiment, a user can select a flow button with which a flow has already been registered and execute registration processing on this flow. Consequently, a plurality of processing flows can be registered with one flow button.

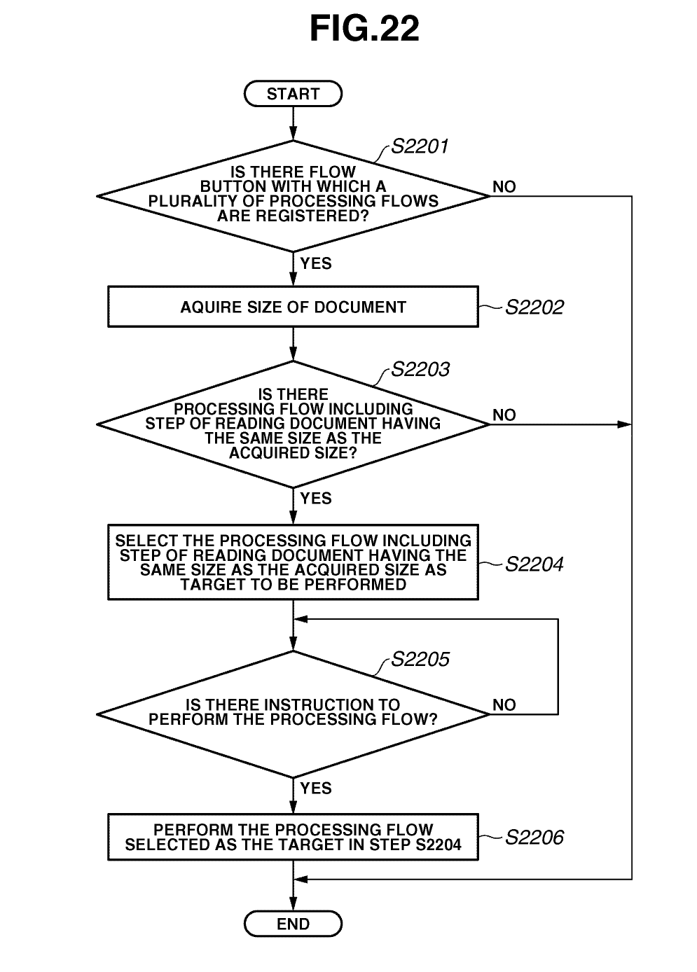

Next, practical processing according to the fourth exemplary embodiment is described below with reference to a flowchart illustrated in FIG. 22.

In step S2201, the flow control unit 0119 analyzes processing flows, which are stored in the storage 0111 and are associated with flow buttons, and determines whether there is a flow button with which a plurality of processing flows are registered.

In a case where it is determined in step S2201 that there is a flow button with which a plurality of processing flows are registered (YES in step S2201), then in step S2202, the flow control unit 0119 acquires the size of a document detected by the detection sensor.

Then, in step S2203, the flow control unit 0119 determines whether a flow including a step of reading a document having a size equal to the size of the document acquired in step S2202 is included in the plurality of processing flows registered corresponding to the flow button. The flow control unit 0119 can analyze the processing flow registered corresponding to each flow button. Consequently, the flow control unit 0119 can make such a determination in step S2203.

In a case where it is determined in step S2203 that there is a processing flow including a step of reading a document having a size equal to the size of a document acquired in step S2202 (YES in step S2203), then in step S2204, the flow control unit 0119 selects the processing flow, which includes a step of reading a document having a size equal to the acquired size of a document, as a target to be executed. In a case where a user instructs to perform the flow (YES in step S2205), then in step S2206, the flow control unit 0119 executes the processing flow selected in step S2204.

According to the present exemplary embodiment, a larger number of processing flows can be made to collectively correspond to one flow button. Consequently, the number of flow buttons to be displayed on an operation screen can be reduced. Also, the user's operability of the image forming apparatus can be improved.

Thus, the image forming apparatus selects a processing flow including a reading step of reading a document having a size, which is equal to the detected size of a document, from among a plurality of processing flows included in one group corresponding to a flow button. Therefore, according to the size detected by the detecting sensor, the processing flow control unit 0119 selects a processing flow, which is expected to be executed next, as a target to be executed. Consequently, the present exemplary embodiment can prevent occurrence of the problem that a user's undesired processing flow is erroneously executed.

The present invention can be achieved by directly or remotely supplying a software program that implements the functions of the above-described exemplary embodiments (a program corresponding to the flowcharts illustrated in the accompanying drawings) to a system or apparatus, and reading out and executing the supplied program code by a computer of the system or apparatus.

Therefore, in order to cause a computer to implement the functions and processes of an exemplary embodiment of the present invention, the program code itself installed in the computer implements the present invention. That is, the computer program itself, which implements the functions and processes, is included in the present invention.

In this case, the form of the program is not limited thereto. Object code, a program to be executed by an interpreter, script data to be supplied to an operating system (OS), and the like can be used as along as having program functions.

Examples of a recording medium for supplying the program are a floppy disk, a hard disk, an optical disk, a magneto-optical disk (MO), a compact-disc-read-only memory (CD-ROM), a CD-recordable (CD-R), a CD-rewritable (CD-RW), a magnetic tape, a nonvolatile memory card, a ROM, a digital versatile disk (DVD (e.g., DVD-ROM, DVD-R)).

Additionally, as another program supply method, the program can be supplied by being connected to a web page on the Internet using a browser on a client computer, and downloading the computer program itself according to the present invention or a compressed file containing an automatic installation function from the web page onto a recording medium such as a hard disk or the like. Also, the program code constituting the program of the present invention can be segmented into a plurality of files, which can be downloaded from different web pages. That is, the present invention includes a world-wide-web (WWW) server enabling a plurality of users to download a program file required to implement the functional process according to the present invention by the computer.

Also, a storage medium, such as a CD-ROM or the like, which stores an encrypted program according to the present invention, can be delivered to a user, a user who meets a predetermined condition can be allowed to download key information that decrypts the program from a web page via the Internet, and the encrypted program can be executed using the key information to be installed on a computer, thus implementing the present invention.

The functions of the above-described exemplary embodiments can be implemented not only by executing the readout program code by the computer but also by some or all of actual processing operations executed by an operating system (OS) or the like running on the computer according to an instruction of the program.

Further, the functions of the above-described exemplary embodiments can be implemented by some or all of actual processes executed by a CPU or the like provided in a function expansion board or a function expansion unit, which is inserted in or connected to the computer, after the program read out from the recording medium is written in a memory of the function expansion board or unit.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-341405 filed Dec. 19, 2006, which is hereby incorporated by reference herein in its entirety.

What is claimed is:

1. An image forming apparatus configured to manage a processing flow including a plurality of steps, the image forming apparatus comprising:
a managing unit configured to manage a plurality of processing flows as one group;
a designating unit configured to designate one group managed by the managing unit;
a detecting unit configured to detect a document;
a selecting unit configured to select a processing flow, which is to be executed, from among a plurality of processing flows included in the group designated by the designating unit according to a result of detection of the document by the detecting unit; and
an executing unit configured to sequentially execute a plurality of steps included in the processing flow selected by the selecting unit.

2. The image forming apparatus according to claim 1, wherein the detecting unit detects whether a document is present,
wherein, when the detecting unit determines that a document is present, the selecting unit selects, as a processing flow to be executed, a processing flow including a step of reading a document from among the plurality of processing flows included in the group, and
wherein, when the detecting unit determines that no document is present, the selecting unit selects, as a processing flow to be executed, a processing flow including no step of reading a document from among the plurality of processing flows included in the group.

3. The image forming apparatus according to claim 1, wherein the detecting unit detects a size of a document, and
wherein the selecting unit selects a processing flow including a step of reading a document of a size equal to the size detected by the detecting unit from among the plurality of processing flows included in the group.

4. The image forming apparatus according to claim 1, further comprising a display control unit configured to display a designation portion corresponding to each processing flow managed by the managing unit,
wherein the display control unit changes a display content of a designation portion corresponding to a group of a plurality of processing flows managed by the managing unit according to a result of detection of the document by the detecting unit.

5. The image forming apparatus according to claim 4, wherein the detecting unit detects a size of a document, and
wherein, according to the size of the document detected by the detecting unit, the display control unit displays a processing flow including a step of reading a document of a size equal to the size of the document and a processing flow including no step of reading a document of a size equal to the size of the document in a distinguishable manner.

6. A method for controlling an image forming apparatus configured to manage a processing flow including a plurality of steps, the method comprising:
managing a plurality of processing flows as one group;
designating one group;
detecting a document;
selecting a processing flow, which is to be executed, from among a plurality of processing flows included in the designated group according to a result of detection of the document; and
sequentially executing a plurality of steps included in the selected processing flow.

7. The method according to claim 6, further comprising:
detecting whether a document is present;
selecting, when it is determined that a document is present, a processing flow including a step of reading a document as a processing flow, which is to be executed, from among the plurality of processing flows included in the group, and
selecting, when it is determined that no document is present, a processing flow including no step of reading a document as a processing flow, which is to be executed, from among the plurality of processing flows included in the group.

8. The method according to claim 6, further comprising:
detecting a size of a document; and
selecting a processing flow including a step of reading a document of a size equal to the detected size from among the plurality of processing flows included in the group.

9. The method according to claim 6, further comprising:
displaying a designation portion corresponding to each managed processing flow; and
changing a display content of a designation portion corresponding to a group of a plurality of managed processing flows according to a result of detection of the document.

10. The method according to claim 9, further comprising:
detecting a size of a document; and
displaying, according to the detected size of the document, a processing flow including a step of reading a document of a size equal to the size of the document and a processing flow including no step of reading a document of a size equal to the size of the document in a distinguishable manner.

11. A computer-readable storage medium storing instructions which, when executed by an image forming apparatus, causes the image forming apparatus to perform operations comprising:
managing a plurality of processing flows as one group;
designating one group;
detecting a document;
selecting a processing flow, which is to be executed, from among a plurality of processing flows included in the designated group according to a result of detection of the document; and
sequentially executing a plurality of steps included in the selected processing flow.

12. The computer-readable storage medium according to claim 11, wherein the operations further comprise:
detecting whether a document is present;
selecting, when it is determined that a document is present, a processing flow including a step of reading a document as a processing flow, which is to be executed, from among the plurality of processing flows included in the group, and
selecting, when it is determined that no document is present, a processing flow including no step of reading a document as a processing flow, which is to be executed, from among the plurality of processing flows included in the group.

13. The computer-readable storage medium according to claim 11, wherein the operations further comprise:
detecting a size of a document; and
selecting a processing flow including a step of reading a document of a size equal to the detected size from among the plurality of processing flows included in the group.

14. The computer-readable storage medium according to claim 11, wherein the operations further comprise:
displaying a designation portion corresponding to each managed processing flow; and
changing a display content of a designation portion corresponding to a group of a plurality of managed processing flows according to a result of detection of the document.

15. The computer-readable storage medium according to claim 14, wherein the operations further comprise:
detecting a size of a document; and
displaying, according to the detected size of the document, a processing flow including a step of reading a document of a size equal to the size of the document and a processing flow including no step of reading a document of a size equal to the size of the document in a distinguishable manner.
